(19) United States
(12) Patent Application Publication
(10) Pub. No.: US 2004/0223178 A1
(43) Pub. Date: Nov. 11, 2004

(54) Printer display incorporating real-time imaging

(76) Inventors: Mark L. Brown, Boise, ID (US); Vincent C. Skurdal, Boise, ID (US); Marvin D. Nelson, Meridian, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/431,929

(22) Filed: May 8, 2003

(51) Int. Cl. G06F 3/12; G06F 15/00

(52) U.S. Cl. 358/1.15; 358/1.13

(57) ABSTRACT

A printing system is disclosed herein. One embodiment of the printing system may include a control device having a plurality of states. At least one digital imaging device may be connectable to the control device. In addition, a plurality of printers may be connectable to the control device. The control device being in a first state causes at least one of the digital imaging device to generate first image data and transmit the first image data to a first printer.

### BACKGROUND

Printers used with personal computers are often sold in retail stores. Many retail stores display a plurality of different printers. Consumers may then compare the various printers to one another before making a purchase. For example, customers may want a printer with or without a control panel in a specific location or a printer with a specific type of paper feed.

Many printers have the ability to produce a demonstration page that shows the quality of the printing as well as the speed and noise of the printers. Generally the contents of the demonstration pages are predetermined by manufactures and may not represent the type of images a user would normally print. For example, demonstration pages may be printed using higher quality images then those generated by the user and may be generated under ideal circumstances. The user may want to view a more realistic image when deciding on a printer to purchase.

Some printers may have an internal demonstration mode that is activated when a signal is received, such as from a button being pressed on the printer. Others activated when preselected data instructions are omitted to the printers. In the activated state a preprogramed demonstration page stored in the internal memory prints out. However, printing a demonstration page after the purchase of the printer is seldom necessary. The memory used to store the preprogrammed demonstration page is a waste of memory use and adds unnecessary cost to the manufacture of the printer. Furthermore, because the pages are preprogrammed, all the demonstration pages that print from the printer are the same.

Some retail stores may have a controller such as a demonstration control box having a plurality of buttons or switches located thereon. A user may press a button to initiate the printing of a demonstration page by a printer. In this embodiment a user may readily test several printers at once. The control box may send a signal to a selected printer that stimulates a print command, which causes the selected printer to print an image. However, images that are printed are still beyond the control of the user.

### SUMMARY

A printing system is disclosed herein. One embodiment of the printing system may include a control device having a plurality of states. At least one digital imaging device may be connectable to the control device. In addition, a plurality of printers may be connectable to the control device. The control device being in a first state causes a at least one of the digital imaging device to generate first image data and transmit the first image data to a first printer.

### BRIEF DESCRIPTION OF THE DRAWINGS

FIG. 1 is a block diagram of an embodiment of a printing system.

FIG. 2 is an embodiment of the operation of the printing system of FIG. 1.

FIG. 3 is a front perspective view of an embodiment of a control device as shown in FIG. 1.

FIG. 4 is another embodiment of a printing system.

FIG. 5 is another embodiment of a printing system.

FIG. 6 is an example of a combined image and text data page printed from a selected printer.

FIG. 7 is another embodiment of a printing system.

FIG. 8 is another embodiment of a printing system.

### DETAILED DESCRIPTION

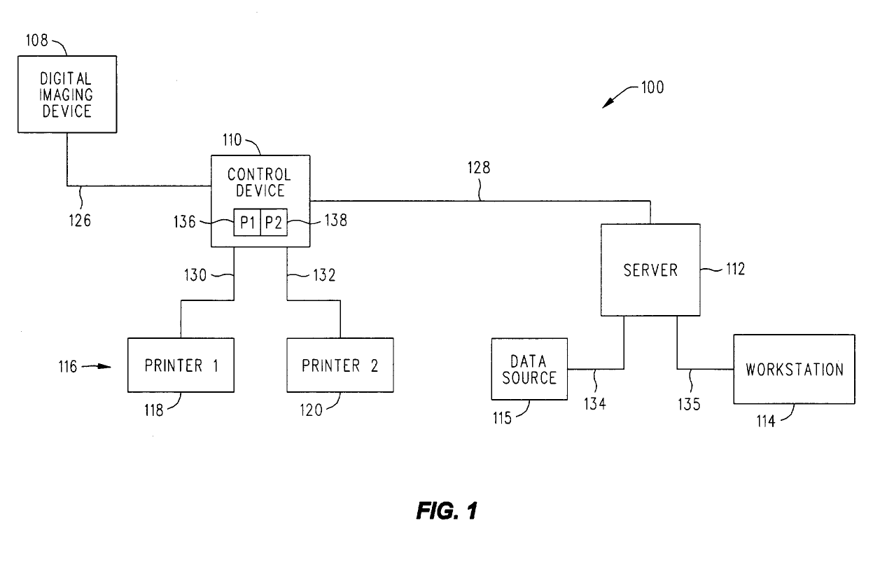

A printing system 100 is described herein, wherein an embodiment of the printing system 100 is shown in FIG. 1. The printing system 100, as an example, may be used in retail outlets to demonstrate the operation of a plurality of printers. In summary, one embodiment of the printing system 100 may serve to cause an image of a user to be printed on one or more of a plurality of printers. This allows potential purchasers (sometimes referred to as users) to view a realistic printed images on a plurality of printers rather then viewing an image selected by a manufacturer or retailer. In addition, the users may get a more personal feel as to the operation of the printers by viewing images of themselves.

Having summarily described an embodiment of the printing system 100, this embodiment and others will now be described in greater detail.

FIG. 1 is a block diagram of an embodiment of a printing system 100. The printing system 100 may include, among other components, a first digital imaging device 108, a control device 110, a server 112, a workstation 114, a data source 115, and a plurality of printers 116. In the embodiment of the printing system 100 of FIG. 1, the printers 116 are referred to individually as a first printer 118 and a second printer 120. In addition, several data lines or the like may interconnect the aforementioned components of the printing system 100.

As briefly mentioned above, the printing system 100 may include several lines that connect the various elements of the printing system 100 to one another. The term “lines” as used herein may be any device or medium that transfers data, these include, but are not limited to, wires, infra red devices, and radio frequency devices. A line 126 connects a first digital imaging device 108 to the control device 110. A line 128 connects the server 112 to the control device 110. The lines connecting the control device 110 to the printers 116 are referred to as line 130 connecting the control device 110 to the first printer 118, and line 132 connecting the control device 110 to the second printer 120. A line 134 connects the server to the data source 115. A line 135 connects the server 112 to the workstation 114. Although each of the aforementioned lines are shown as having single conductors, it should be noted that they may each have a plurality of conductors or the like as described below. Accordingly, the lines may provide parallel data transmissions.

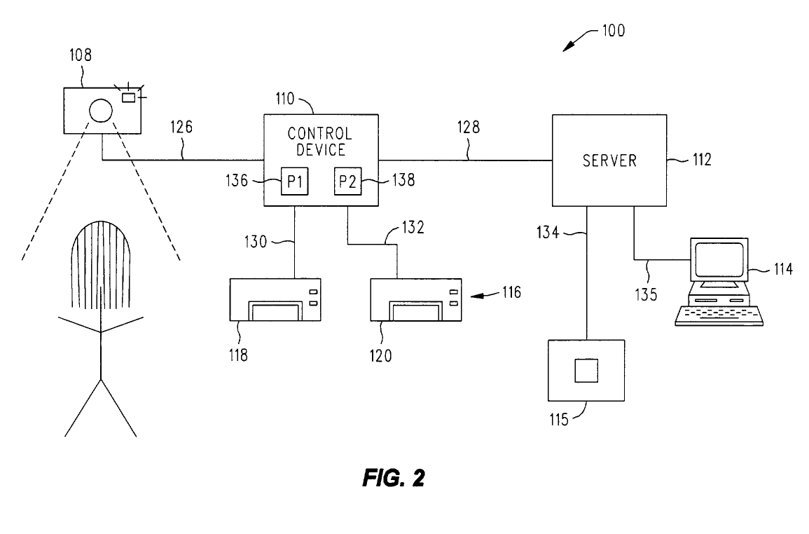

The first digital imaging device 108 may be a device that converts an image of an object to machine-readable image data (sometimes referred to simply as image data). For example, the first digital imaging device 108 can be a digital, still or video camera. The first digital imaging device 108 described herein generates image data upon receiving a command or instruction via the line 126. As described in greater detail below, the first digital imaging device 108 may have an input device (not shown in FIG. 1) and an output device (not shown in FIG. 1), that enable it to be connectable to the control device 110 and the server 112. In FIG. 2, the printing system 100 is configured so that the first digital imaging device 108 is able to capture an image of a user located in the proximity of the control device 110. As described in greater detail below the plurality of printers 116 may then print a replicated image of the user based on image data received via the lines 130 or 132 using the selected printer.

The server 112 may be connected to the control device 110 via the line 128. The server 112 may store image and text data that is to be printed by one of the printers 116 selected by a user. The image data may be received from the first digital imaging device 108 or from other devices such as the work station 114 or the data source 115. The text data may be obtained from outside sources, such as the work station 114 or data source 115. The text data may also be stored in a memory device within a printer 116. As described in greater detail below, the server 112 may transmit data to and receive data from the control device 110 and other components of the printing system 100. Accordingly, the server 112 may have input devices and output devices (not shown in FIG. 1) that serve to transmit and receive data. In some embodiments of the printing system 100, the data stored in the server 112 can be changed and/or updated at anytime. For example, the work station 114 or the data source 115 may be used to update or modify the data or instructions stored within the server 112.

The workstation 114 may be connected to the server 112 via the line 135. The workstation 114 may, as an example, be a personal computer and may contain software that combines the image data and text data into a single document. For example, the software may cause a printer to produce document containing both a picture and text. The picture may be representative of image data generated by the first digital imaging device 108 and the text may be provided by an external source and may contain information about the printers 116.

The data source 115 may be connected to the server 112 via the line 134. The data source 115 may store data, such as software instructions and text data, and may transmit this data to and from the server 112. In one embodiment, the data source is a server or the like and the line 134 is an Internet connection or the like. Such a configuration may enable the server 112 to be connectable to a central office, such as a central office of a retail outlet. This connection may allow an external source, such as a retail outlet, to determine the data that is printed by the printers 116. For example, if the central office wants to promote the first printer 118 for a few hours, it can cause instructions to be transmitted to the server 112 which cause promotions to be printed by the first printer 118. Accordingly, the aforementioned promotional information may be printed from the first printer 118 when the first printer 118 is selected to print by a user.

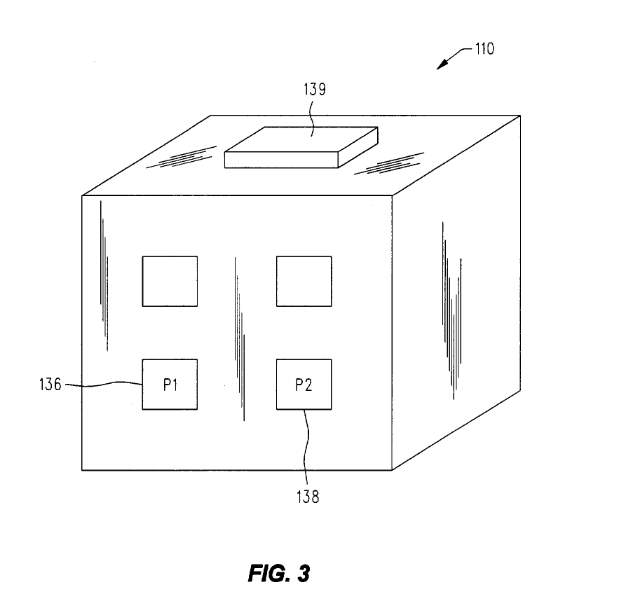

FIG. 3 is a front perspective view of an embodiment of the control device 110. The control device 110 is the user interface for the printing system 100. The control device 110 described herein may have a plurality of switches (sometimes referred to herein as selectors), located thereon. Referring to FIGS. 2 and 3, the number of switches located on the control device may correspond to the number of printers 116 connected to the control device 110. In the embodiment of the printing system 100, two printers 116 and 118 are connected to the control device 110. Accordingly, the control device 110 has two switches located thereon, which are referred to as a first switch 136 and a second switch 138. The switches 136, 138 serve to enable the user to choose which printer is to be activated. For example, the switches 136, 138 may be buttons or the like that are connected to and activate preselected printers upon being toggled or otherwise switched.

In addition to the switches, the control device 110 may have a communication device 139 attached thereto. The communication device 139 serves to transmit and receive data to and from other components of the printing system 100. In the embodiments of the printing system 100 having hardwired components, the communication device 139 may be an electrical connector. In the embodiment of the printing system 100 using infrared or radio frequency transmissions between components, the communication device 139 may be an infrared or radio frequency transceiver.

In example of the control device depicted in FIGS. 2 and 3, the first switch 136 may be operatively connected to the first printer 118 and the second switch 138 may be operatively connected to the second printer 120. Thus, the first printer 118 is activated when the first switch 136 is toggled or otherwise switched. Likewise, the second printer 120 is activated when the second switch 138 is toggled. As described in greater detail below, when a switch is toggled, the first digital imaging device 108 becomes activated via the line 126 and captures an image. The image data representative of the image is transmitted through the control device 110 and to the printer corresponding to the toggled switch. The image represented by the image data is then printed. In some embodiments, the image data may also be combined with text data stored in the server 112 so that both the image and the text are printed.

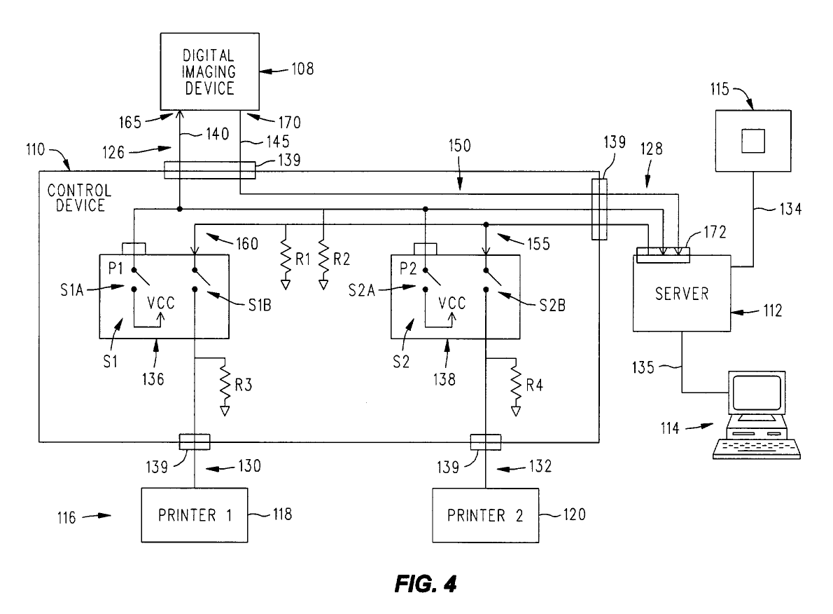

FIG. 4 is a more detailed schematic diagram of an embodiment of the printing system 100 of FIGS. 1 and 2 and is provided to describe an embodiment of the operation of the printing system 100. Many of the lines shown in FIGS. 1 and 2 as being single lines are shown in FIG. 4 as being multiple lines. This provides for a better illustration of the flow of data and instructions throughout the printing system 100. The line 126 shown in FIGS. 1 and 2 is a combination of two lines 140 and 145 extending between the control device 110 and the first digital imaging device 108. The same is applicable for line 128, which is a combination of lines 155 and 160 extending between the server 112 and the control device 110.

The first digital imaging device 108 may include an input 165 that serves to receive data transmitted from the control device 110. The first digital imaging device 108 may also include an output 170 that serves to transmit from the first digital imaging device 108. The server 112 also has a transceiver device 172 located thereon that serves to receive and transmit data.

FIG. 4 shows an embodiment of the connections and components that may be included within the control device 110. As shown in FIG. 4, the switches 136 and 138 include toggle switches, which are referred to as S1 and S2, respectively. Each of the switches Si and S2 are double switches. The switch S1 includes switches S1A and S1B. Likewise, the switch S2 includes switches S2A and S2B. Each of the switches has two states, open and closed. The switches are shown as being mechanical-type switches. The switches however, may be any device that controls current flow, such as electronic switches, i.e., FETs. The switches may also be associated with timers so that the time they remain closed or conducting is predetermined. For example, the switches S1B and S2B may remain closed for a period long enough to transfer image data to the printers 116.

As shown in FIG. 4, the switch S1A is connected between a power supply (VCC) and the input 165 of the first digital imaging device 108. The switch S2A is also connected between the power supply and the input 165 of the first imaging device 108. Accordingly, when either switch S1A or S2A are closed, a voltage is present on the input 165 of the first digital imaging device 108. As described in greater detail below, the voltage present at the input 165 of the first imaging device 108 causes the first imaging device 108 to capture an image. Image data representative of the captured image is transmitted from the first imaging device 108 via the output 170. It should be noted that the use of the voltage signal described above is for illustration purposes only and that other signals or instructions may be used to activate the first imaging device. For example, a binary number may be transmitted to the first imaging device 108 upon activation of a switch S1A or S2A.

The switches S1B and S2B are connected between a data source and individual printers. In the embodiment of the printing system 100 depicted in FIG. 4, the data source is the server 112, however, it is to be understood that the data source may be virtually any device that generates or stores data representative of printed material. When the switch S1B is closed, data is transferrable from the data source to the first printer 118. Likewise, when the switch S2B is closed, data is transferrable from the data source to the second printer 120.

The control device 112 of FIG. 4 includes a plurality of pull down resistors. The pull down resistors provide for certain lines within the control device 112 to be at a zero or ground potential unless a voltage is applied. A resistor R1 serves to maintain the line 160 at a ground potential unless the server causes the line 160 to be at a different potential. The resistor R2 maintains the line 140 at a ground potential unless either switch S1A or S2A is closed. Therefore, the first digital imaging device will not misinterpret noise as a voltage signal generated by the control device 112. A resistor R3 and a resistor R4 maintain the lines 130 and 132 and ground potentials unless data is transmitted via the lines 130, 132. Therefore, the printers 116 will not misinterpret noise as data or instructions.

Having described the components of the printing system 100 of FIG. 4, the operation of the printing system 100 will now be described.

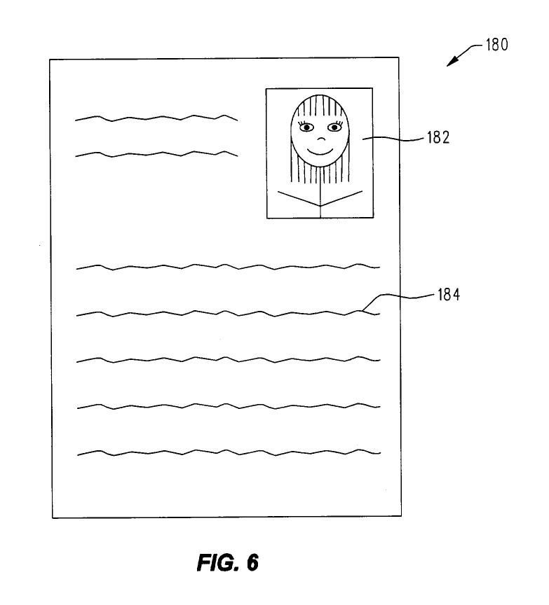

In summary, the printing system 100 serves to demonstrate the operation of a printer that is selected by way of either switch 136 or 138. The demonstration of the selected printer includes printing an image of the user of the printing system 100. This is achieved by capturing an image of the user, who should be in the proximity of the control device 112 and transmitting the image data representative of the image of the user to the selected printer. Additional text data may be added to the image by the server 112. The text data may, as an example, include promotional materials related to the operation of the selected printer. An example of a document 180 that may be printed by the selected printer is shown in FIG. 6. In the embodiment of FIG. 6, an image 182 of the user is printed on the document 180 along with text 184.

Having summarily described the printing system 100, it will now be described in greater detail below. Referring briefly to FIG. 2, the operation of the printing system 100 commences with the user selecting a printer by toggling either the first switch 136 or the second switch 138 on the control device 112. The control device 112 may be situated relative to the first digital imaging device 108 so that the user must be in the field of view of the first digital imaging device 108 in order to toggle either the first switch 136 or the second switch 138.

For illustration purposes, it will be assumed that the user toggles the switch S1 in order to assess the operation of the first printer 118. Referring again to FIG. 4, when the switch S1 is closed, both switches S1A and S1B close. When switch S1A closes, a voltage signal becomes present at the input 165 of the first digital imaging device 108 via the line 140. In addition, the voltage signal becomes present at the server 112. The voltage signal enables the server 112 to prepare to receive an image data generated by the first digital imaging device 108.

The voltage signal being present at the input 165 of the first imaging device 108 causes the first digital imaging device 108 to capture an image of an object located in the proximity of the control device 110. As described above, the object in the proximity of the control device 110 may be the user of the printing system 100. The first digital imaging device 108 may then transmit the image data representative of the user to the server 112 via the line 150.

The server 112 receives the image data and may combine the image data with text data. The text data may be received from the workstation 114 or the data source 115 and may form a page represented by an image of the user and text data. It should be noted that the server 112 may be programmed via the workstation 114 or the data source 115. Likewise, the text data may be transmitted from the workstation 114 or the data source 115 to the server. Accordingly, either the workstation 114 or the data source 115 may determine how the page is to be displayed and the information that is to be displayed. For example, the workstation 114 may program the server to print promotional material during a preselected period in addition to an image of the user.

When the server 112 has processed the text data and the image data, the server 112 then transmits the combined image data and text data to the control device via the line 160. As described above, in the following example, the user toggled the switch S1. Accordingly, the switch S1B is closed, which causes the aforementioned data to be routed to the first printer 118 via the line 130. Upon receiving the aforementioned data, the first printer 118 prints the based on the data. Thus, an image of the user and any text provided by the server 112 is printed by the first printer 118.

An briefly described above, FIG. 6 shows an embodiment of a document 180 including a combination of an image 182 and text 184. The image portion of the document 180 includes a replicated image of the user captured by the first digital imaging device 108. The text 184 may be any text stored in or transmitted to the server 112. For example the text 184 may include information related to the operation or promotion of the selected printer. It should be noted that the text 184 may include images and text. It should also be noted that instructions stored in the server 112, FIG. 2, may determine the layout of the image 182 and the text 184 on the document 180. In addition, these instructions may be changed via the workstation 114 or the data source 115.

The user may also observe the print function of the second printer 120 by toggling the second switch 138. Toggling the second switch S2 is the same as toggling the first switch S1, except that the data transmitted from the server 112 is routed to the second printer 120 instead of the first printer 118. It should be noted that in one embodiment of the printing system, both switches S1B and S2B are closed, which causes both of the printer 116 to receive data and print images representative of the data.

Having described some embodiments of the printing system, other embodiments will now be described.

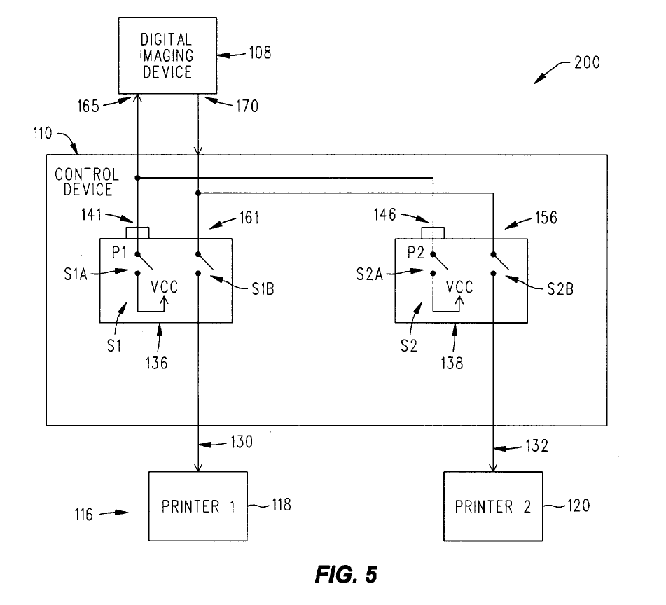

Another embodiment of a printing system is shown in FIG. 5 and is referenced as the printing system 200. The printing system 200 is similar to the printing system 100 described above, except the printing system 200 does not include a server or its related data sources. When a user demonstrates a printer 116 using the printing system 100, only the image of the printer and possibly data stored in the printers 116 is printed. As described above, a demonstration of the first printer 118 is commenced by toggling the first switch S1. Toggling the first switch S1 causes the voltage (VCC) to be present at the input 165 of the first digital imaging device 108 via the switch S1A to close. When voltage is present at the input 165 of the first imaging device 108, the first digital imaging device 108 captures an image.

The image data generated by the first digital imaging device 108 is transmitted via the output 170 to the control device 110. As set forth above, when the first switch S1 closes, the switch S1B also closes. Therefore, the image data is transferred directly to the first printer 118. The first printer then prints an image represented by the image data generated by the first digital imaging device 108. It should be noted that the printers 116 may insert text information into the document containing the aforementioned image. The text may, as an example, include information pertaining to a specific printer.

Referring again to FIG. 2 and as described above, closing the switch S1A causes a voltage signal to be present at the input 165 of the first digital imaging device 108 and at the server 112. Another embodiment of the printing system causes a signal to be transmitted to both the first digital imaging device 108 and the server 112 upon the switch S1B closing. This signal serves to identify that a demonstration of the first printer 118 is sought. For example, the signal may be a serial data transmission representative of a binary one. The server 112 then outputs data specific to the first printer 118, which is then printed by the first printer 118. In a similar manner another signal may be transmitted when the switch S2A is closed. This signal may represent a binary one, which is indicative of a demonstration of the second printer 120 being sought. In such an embodiment, the printing system 100 may use a single line between the switches S1B, S2B, and the input to the server 112.

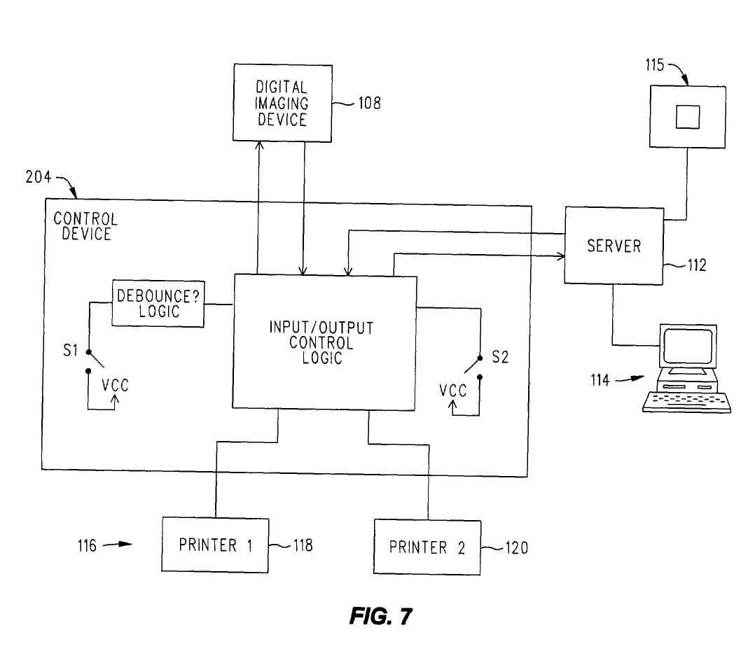

One example of the above-described embodiment is shown in FIG. 7. A control device 204 includes input/output control logic 206 that receives input data and outputs preselected data based on the input data. In the example provided in FIG. 7, the input/output logic 206 detects whether switch S1 or S2 is closed. When either the switch S1 or S2 is closed, data is sent to the digital imaging device 108 via the line 140, which causes the digital imaging device 140 to capture an image and transmit the generated image data to the input/output control logic 206 via the line 145. Data is also sent from the input/output control logic 206 to the server 112 to indicate which switch and, thus, which printer 116 was selected for printing. Depending on which printer 116 has been selected, the server 116 may select data to print. The data may include specification about the selected printer or promotional items. The data from the server is then combined with the image data and send to the selected printer for printing. It should be noted that the image data generated by the digital imaging device 108 may be transmitted to the server 112 where it is combined with other data and then transmitted to the selected printer.

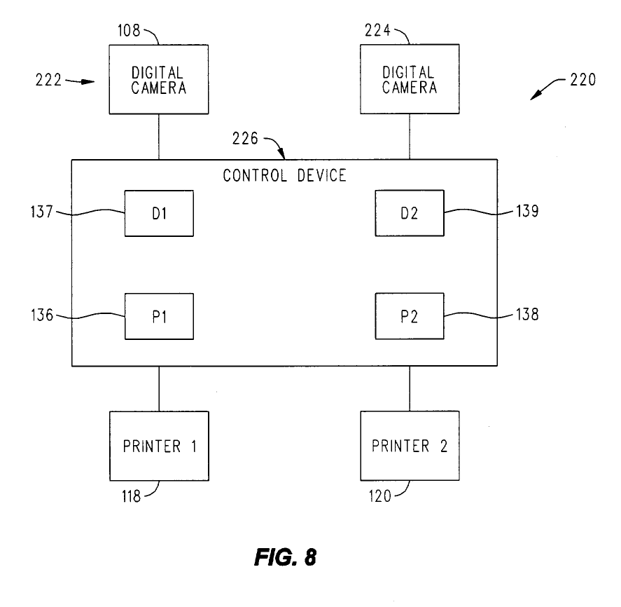

Another embodiment of a printing system 220 is shown in FIG. 8. In the embodiment of the printing system 220 of FIG. 2, a plurality of digital imaging devices 222 are connected to a control device 226. The printing system 220 enables demonstrations of different imaging devices and different printers as described in greater detail below. The digital imaging devices 222 include the first digital imaging device 108 and a second digital imaging device 224. As with the previous embodiments, a plurality of printers 116 are connected to the control device 226. The control device 226 may have a plurality of switches located thereon. More specifically, the control device 226 may have one switch for each printer and digital imaging device connected thereto. The switches located on the control device 226 are referred to as D1, D2, P1, and P2. The switch D1 is operatively connected to the first digital imaging device 108, the switch D2 is operatively connected to the second digital imaging device 224, the switch P1 is operatively connected to the first printer 118, and the switch P2 is operatively connected to the second printer 120.

The printing system 220 operates in a manner similar to the printing systems described above, however, the printing system 220 enables a user to select a specific digital imaging device to generate image data. Both the first digital imaging device 108 and the second digital imaging device 224, when selected or activated, capture an image of an object located in the proximity of the control device 226, which may be the user. Selection of the digital imaging device that captures the image consists of toggling the switch operatively connected to the desired digital imaging device. For example, toggling the switch D1 will cause the first digital imaging device 108 to capture an image. The printer used to print the image is selected by toggling the switch that is operatively connected to the desired printer. For example, toggling the switch P2 will cause the image captured by the first digital imaging device 108 to be printed by the second printer 120.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A printing system comprising:
a control device having a plurality of states;
at least one digital imaging device connectable to said control device; and
a plurality of printers connectable to said control device;
wherein said control device being in a first of said plurality of states causes a first of said at least one digital imaging device to generate first image data, and transmit said first image data to a first of said plurality of printers.

2. The printing system of claim 1, wherein said first printer prints an image upon receipt of said first image data, and wherein at least one portion of said image is represented by said first image data.

3. The printing system of claim 1, wherein said first image data is representative of an image captured in the proximity of said control device.

4. The printing system of claim 1, wherein said control device comprises at least one switch, and wherein toggling of said at least one switch causes said control device to enter at least one of said plurality of states.

5. The printing system of claim 1 and further comprising a data storage device connectable to said control device and wherein second image data is storable in said data storage device.

6. The printing system of claim 5, wherein at least a portion of said second image data is representative of text.

7. The printing system of claim 5, wherein said control device being said first state causes said first printer to print an image and wherein said image printed by said first printer comprises said first image data and second image data.

8. The printing system of claim 1, wherein said control device being in a second of said plurality of states causes said first image data to be transmitted to a second of said plurality of printers.

9. The printing system of claim 1, wherein said control device being in a third of said plurality of states causes a second of said at least one digital imaging device to generate third image data and transmit said third image data at least one of said plurality of printers.

10. The printing system of claim 1, wherein said control device being in a fourth of said plurality of states causes said first image data to be transmitted to at least a first one and a second one of said plurality of printers.

11. A method for printing comprising:
selecting a first printer from a plurality of printers operatively connected to at least one digital imaging device;
generating a first image data using a digital imaging device upon said selection, said image data being representative of an image of a preselected location;
transmitting said first image data to said first printer; and
printing an image using said first printer, wherein at least one portion of said image is representative of said first image data.

12. The method of claim 11 and further comprising transmitting second image data to said first printer, wherein said at least one portion of said image is representative of said first image data and at least one second portion of said image is representative of said second image data.

13. The method of claim 11, wherein said selecting comprises toggling a switch on a control device and wherein said control device is located proximate said preselected location.

14. The method of claim 11, wherein said selecting comprises selecting a first printer and a second printer, wherein said transmitting comprises transmitting said first image data to said first printer and said second printer, and wherein said image is printed using said first printer and said image is printed using said second printer.

15. A method for printing comprising:
selecting a first imaging device from a plurality of imaging devices, wherein said selecting causes said first imaging device to generate image data representative of an image of a preselected location;
transmitting said first image data to a first printer of a plurality of printers; and
printing an image using a first printer from a plurality of printers, at least one portion of said image being representative of said first image data.

16. The method of claim 15 and further comprising transmitting second image data to said first printer, wherein said at least one portion of said image is representative of said first image data and at least one second portion of said image is representative of said second image data.

17. The method of claim 15, wherein said selecting comprises toggling a switch on a control device and wherein said control device is located proximate said preselected location.

18. The method of claim 15 and further comprising selecting a second printer of said plurality of printers.

19. The method of claim 15, wherein said selecting comprises selecting a first printer and a second printer, wherein said transmitting comprises transmitting said first image data to said first printer and said second printer, and wherein said image is printed using said first printer and said second printer.

20. A printing system comprising:
a plurality of printers;
a selection means for selecting at least one of said plurality of printers; and
an imaging means operatively connected to said plurality of printing devices for generating image data representative of an image in the proximity of said selection means;
wherein said image data is transmitted to said at least one printer.

21. A printing system comprising:
at least one imaging device for generating image data, said at least one imaging device being operatively connected to a plurality of printing devices;
a selection means for selecting one of said at least one imaging device; and
a plurality of printing devices operatively connected to said at least one imaging device; wherein said image data is transmittable to at least one of said plurality of printing devices.
